(19) United States
(12) Patent Application Publication
(10) Pub. No.: US 2026/0112017 A1
(43) Pub. Date: Apr. 23, 2026

(54) DEFECT INSPECTION DEVICE, DEFECT INSPECTION METHOD, TEACHER DATA GENERATION METHOD, AND DETERMINATION MODEL GENERATION METHOD

(71) Applicant: Kabushiki Kaisha F.C.C., Shizuoka (JP)

(72) Inventors: Motoki OKAZAKI, Shizuoka (JP); Shun MURAKAMI, Shizuoka (JP); Tomomi KURATA, Shizuoka (JP); Anju MURAI, Shizuoka (JP); Shoma IWASHITA, Nagano (JP)

(73) Assignee: Kabushiki Kaisha F.C.C., Shizuoka (JP)

(21) Appl. No.: 19/148,063

(22) PCT Filed: Nov. 16, 2023
(86) PCT No.: PCT/JP2023/041254

§ 371 Date: Jul. 15, 2025

(30) Foreign Application Priority Data
Feb. 14, 2023 (JP) 2023-020853

(51) Int. Cl. G06T 7/00; G06T 7/73

(52) U.S. Cl. CPC G06T 7/0004; G06T 7/73; G06T 2207/20081

(57) ABSTRACT

An inspection image generation unit 12 configured to perform image processing on a captured image of an annular disk, and draws an auxiliary line in the vicinity of a position where a plurality of frame members exist to generate an inspection image equipped with auxiliary lines, and a defect determination unit 13 configured to apply the generated inspection image equipped with auxiliary lines to a trained determination model to detect a positional deviation of the frame members are provided. According to this, it is not necessary to set a specified value for comparison with various calculation values calculated for the frame members through image processing, and even in a case where a noise is included in the captured image, it is possible to reduce the possibility of occurrence of erroneous determination by an adverse effect on the comparison between the calculation values and the specified value due to the noise. In addition, it is easy to perform learning and determination of the positional deviation occurring in the frame members by using the auxiliary line as a reference.

### TECHNICAL FIELD

The present invention relates to a defect inspection device, a defect inspection method, a training data generation method, and a determination model generation method, and particularly, to a technology of detecting a defect related to positional deviation of a plurality of frame members arranged with predetermined intervals in a circumferential direction along a surface of an annular disk.

### BACKGROUND ART

In the related art, there is known a device for inspecting the quality of friction plates used in clutch devices, brake devices, and the like of vehicles (for example, refer to Patent Literature 1). A plurality of frame members are attached to a surface of the friction plate formed in an annular shape at a predetermined interval in a circumferential direction, and the performance of the friction plate depends on an attachment state of the plurality of frame members. In the inspection device described in Patent Literature 1, a positional deviation of the frame members and the like are inspected as the quality of the friction plate based on image data obtained by imaging the friction plate.

In the inspection device described in patent

Literature 1, image processing is performed on the image data to generate two circular regions having radii of r1 and r2 from center coordinates of the friction plate, and a difference region between the two circular regions is extracted to generate an annular region to which the frame members are attached. Then, an image corresponding to the annular region is extracted from the image data to narrow an analysis region, and predetermined image processing is performed on the narrowed image to determine the positional deviation of the frame members.

### CITATION LIST

### Patent Literature

According to the inspection device described in Patent Literature 1, it is possible to reduce the possibility of overlooking of the positional deviation of the frame members as compared with a case of performing determination of the quality of the friction plate by visual observation by an operator. However, since the area of the frame members, an average gray value, an area protruding from the annular region, an arc distance between the frame members, and the like are calculated by performing the image processing on the image data, and the calculation values are compared with respective specified values to determine the positional deviation of the frame members, it is necessary to set the respective specified values in advance.

Therefore, when the specified values are not set appropriately in correspondence with the friction plate that is an inspection target, there is a problem that erroneous determination of the positional deviation may occur. In addition, a noise may be included in the image data of the friction plate which is generated by the image processing, and thus there is also a problem that the noise may have an adverse effect on the comparison between the calculation values and the specified values, and thus an erroneous determination may occur.

PTL 1: JP2002-318196A

### SUMMARY OF INVENTION

### Technical Problem

The invention has been made to solve the problems, and an object thereof is to improve the performance of detecting a positional deviation of frame members.

### Solution to Problem

To solve the problem, in the invention, image processing is performed on an image obtained by imaging a plurality of frame members, and an auxiliary line is drawn at a predetermined position near a position where the plurality of frame members exist to generate an inspection image equipped auxiliary lines. In addition, the generated inspection image equipped with auxiliary lines is applied to a learned determination model by using training data to detect a defect related to the positional deviation in any one of the plurality of frame members. Here, the determination model is generated by machine learning processing using training data including a training image equipped with auxiliary lines similar to the inspection image equipped with auxiliary lines, and the determination model outputs defect information related to the positional deviation when the inspection image equipped with auxiliary lines is input.

### Advantageous Effects of Invention

According to the invention configured as described above, since the positional deviation of the frame members is determined by using the determination model generated by machine learning using the training data instead of determining the positional deviation based on various values calculated for the frame member through image processing on a captured image, it is not necessary to set a specified value for comparison with calculation values. Accordingly, even in a case where a noise is included in the captured image, it is possible to reduce the possibility of occurrence of erroneous determination by an adverse effect on the comparison between the calculation values and the specified value due to the noise. In addition, since the determination of the positional deviation is performed based on the inspection image equipped with auxiliary lines by using the determination model generated by the machine learning using the training image equipped with auxiliary lines as the training data, it is easy to make learning and determination of the positional deviation occurring in the frame members easy by using the auxiliary line as a reference. As described above, according to the invention, it is possible to improve detection performance of the positional deviation of the frame members.

### BRIEF DESCRIPTION OF DRAWINGS

FIG. 1 is a block diagram illustrating a functional configuration example of a defect inspection device according to an embodiment.

FIG. 2 is a view illustrating an example of a captured image of an annular disk, and an example of various types of annular disk.

FIG. 3 is a view illustrating processing contents of an inspection image generation unit according to this embodiment.

FIG. 4 is a block diagram illustrating a functional configuration example of a training data generation device according to this embodiment.

FIG. 5 is a view illustrating a type of a positional deviation.

FIG. 6 is a view illustrating a generation example of a plurality of defective product images which are different in the amount of positional deviation.

FIG. 7 is a block diagram illustrating a functional configuration example of a determination model generation device according to this embodiment.

FIG. 8 is a flowchart illustrating an operation example of the training data generation device according to this embodiment.

FIG. 9 is a flowchart illustrating an operation example of the determination model generation device according to this embodiment.

FIG. 10 is a flowchart illustrating an operation example of the defect inspection device according to this embodiment.

FIG. 11 is a view illustrating results obtained by performing a defect inspection on a plurality of annular disks by using a determination model configured to detect presence or absence of a positional deviation.

FIG. 12 is a view illustrating results obtained by performing a defect inspection on a plurality of annular disks by using a determination model configured to detect the degree of the positional deviation.

FIG. 13 is a view illustrating results obtained by performing detection on a circumferential deviation based on three determination models different in detection performance.

### DESCRIPTION OF EMBODIMENTS

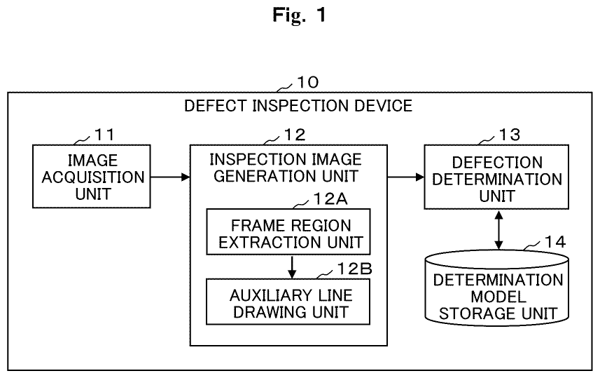

Hereinafter, an embodiment of the invention will be described with reference to the accompanying drawings. FIG. 1 is a block diagram illustrating a functional configuration example of a defect inspection device 10 according to this embodiment. As illustrated in FIG. 1, the defect inspection device 10 of this embodiment includes an image acquisition unit 11, an inspection image generation unit 12, and a defect determination unit 13 as functional configurations. The inspection image generation unit 12 includes a frame region extraction unit 12A and an auxiliary line drawing unit 12B as specifical functional configurations. In addition, the defect inspection device 10 of this embodiment includes a determination model storage unit 14 as a storage medium.

The functional blocks 11 to 13 can be configured by any of hardware, a digital signal processor (DSP), and software. For example, in a case of being configured by the software, the functional blocks 11 to 13 are actually configured with a CPU, a RAM, a ROM, and the like of a computer, and are realized when a program stored in a storage medium such as the RAM, the ROM, a hard disk, or a semiconductor memory operates. Instead of or in addition to the CPU, a graphic processing unit (GPU) , a field programmable gate array (FPGA), an application specific integrated circuit (ASIC), or the like may be used.

The image acquisition unit 11 acquires an image that is obtained by imaging a surface of an annular disk that is an object to be inspected. The captured image of the annular disk is an image that is obtained by imaging the annular disk by a camera from a predetermined position under a predetermined imaging condition. For example, the annular disk is moved to a predetermined imaging position by a conveyance mechanism such as a belt conveyor, and the annular disk is imaged by the camera installed at the imaging position. The image acquisition unit 11 acquires the image of the annular disk imaged by the camera.

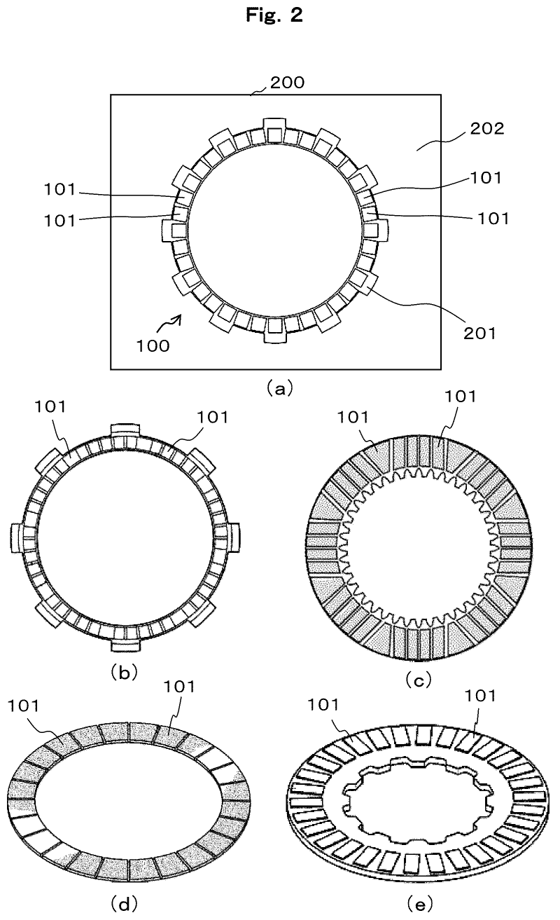

The annular disk is, for example, a clutch disk or a brake disk that is used in a clutch device or a brake device of a vehicle, or the like. FIG. 2 is a view illustrating an example of a captured image of the annular disk and an example of various types of annular disk. A captured image 200 shown in FIG. 2(a) shows a state in which an annular disk 100 is imaged from a front surface (surface on which a plurality of frame members 101 are disposed), and includes a product region 201 where the annular disk 100 is imaged, and a background region 202 other than the annular disk 100.

As shown in FIG. 2(a), the annular disk 100 includes the plurality of frame members 101 arranged side by side with predetermined intervals in a circumferential direction along a surface. Each of the frame members 101 is, for example, a friction material formed from a paper material or the like, and is fixed to the surface of the annular disk 100. For example, the clutch device is configured such that a clutch disk and a clutch plate are pressed against each other via the friction material to transmit power between an engine side and a wheel side, and transmission of the power is blocked by releasing the pressing force.

Note that the configuration of the annular disk 100 shown in FIG. 2(a) is illustrative only, and there is no limitation to the configuration. For example, as shown in FIG. 2(b) to 2(e), the shape, number, size, and the like of the frame member 101 vary depending on product types, and an annular disk 100 of any of the types can also be used as an object to be inspected. As shown in FIG. 2(b) and 2(c), it is not essential that all of the frame members 101 have the same shape.

The inspection image generation unit 12 performs image processing on the image acquired by the image acquisition unit 11, and draws a circular auxiliary line at a predetermined position near a position where the plurality of frame members 101 exist to generate an inspection image equipped with auxiliary lines. When generating the inspection image equipped with auxiliary lines, a frame region extraction unit 12A generates an extraction image obtained by extracting the plurality of frame members 101 or a region where the plurality of frame members 101 are disposed from the image acquired by the image acquisition unit 11.

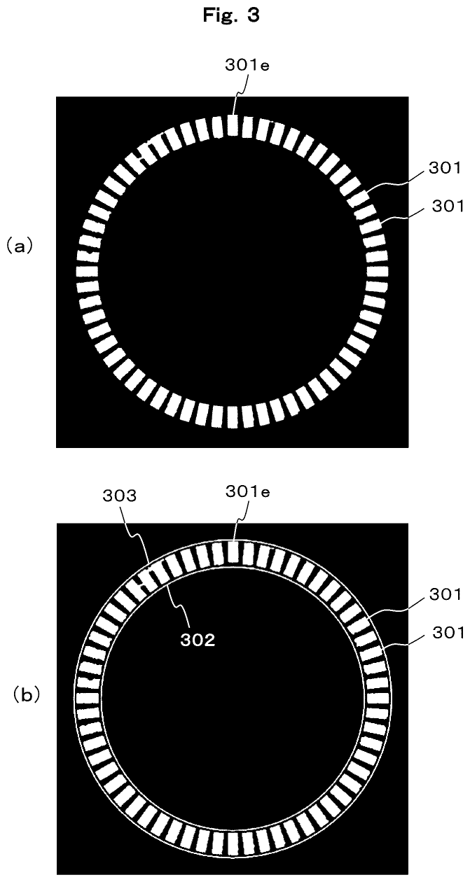

FIG. 3 is a view illustrating processing contents of the inspection image generation unit 12. FIG. 3(a) is a view illustrating an example of the extraction image generated by the frame region extraction unit 12A. For example, the frame region extraction unit 12A binarizes the captured image acquired by the image acquisition unit 11, and then detects frame regions 301 corresponding to the plurality of frame members 101, and deletes (whitens) an image in the other regions. Then, the inside of the frame regions 301 is painted in black, and a black and white gradation is inverted to generate an extraction image shown in FIG. 3(a). As shown in FIG. 3(a), the plurality of frame regions 301 are basically separate regions, but due to an influence of a noise or the like that occurs during imaging or image processing, adjacent regions may be connected by a thin line or o the shape of the regions may be partially deformed.

The auxiliary line drawing unit 12B draws an auxiliary line at a predetermined position near a position where the plurality of frame members 101 (frame regions 301) exist in the extraction image generated by the frame region extraction unit 12A to generate an inspection image equipped with auxiliary lines. Note that in the following description, “frame members 101” in description related an image means an image of the frame regions 301. FIG. 3(b) is a view illustrating an example of the inspection image equipped with auxiliary lines which is generated by drawing auxiliary lines 302 and 303 with respect to the extraction image shown in FIG. 3(a).

FIG. 3(b) shows an example in which an inner circumferential circle 302 on an inner side of the plurality of frame members 101 and an outer circumferential circle 303 on an outer side of the plurality of frame members 101 are drawn as auxiliary lines in the vicinity of the position where the plurality of frame members 101 (frame regions 301) exist. For example, the auxiliary line drawing unit 12B sets a circle that connects outer edges (or inner edges) of the plurality of frame regions 301 with an arc, and draws a circle with a radius r₁ as the inner circumferential circle 302 and a circle with a radius r₂ (r₁<r₂) as the outer circumferential circle 303 to be concentric with the circle. Values of the radii r₁ and r₂ are set in advance based on specifications of the annular disk 100 that is set as an inspection target.

Note that a drawing direction of the inner circumferential circle 302 and the outer circumferential circle 303 is not limited thereto, and may be, for example, as follows. That is, the auxiliary line drawing unit 12B sets an inscribed circle that connects inner edges of the plurality of frame areas 301 with an arc, and calculates a radius r₁′ of the inscribed circle. Then, a circle that is concentric with the inscribed circle and has a radius r₁ (r₁=r₁′−Δ) slightly smaller than the radius of the inscribed circle is drawn as the inner circumferential circle 302. In addition, the auxiliary line drawing unit 12B sets a circumscribed circle that connects outer edges of the plurality of frame regions 301 with an arc, and calculates a radius r₂′ of the circumscribed circle. Then, a circle that is concentric with the circumscribed circle and has a radius r₂ (r₂=r₂′+Δ) slightly larger than the radius of the circumscribed circle is drawn as the outer circumferential circle 303.

Here, description has been given of an example in which two circles including the inner circumferential circle 302 and the outer circumferential circle 303 are drawn as the auxiliary lines 302 and 303, but either one may be used. In addition, there, description has given of an example in which the auxiliary lines 302 and 302 are drawn at positions that do not overlap the plurality of frame regions 301, but the auxiliary lines 302 and 303 may be drawn at overlapping regions.

In the example of the image shown in FIG. 3, a positional deviation with respect to a radial direction occurs in one frame region 301e. That is, the frame region 301e exists at a position slightly deviated to an outer side in the radial direction as compared with the original correct position. As can be seen from comparison between FIG. 3(a) and 3(b), in a case where the auxiliary lines 302 and 303 exist, it is possible to clearly recognize the positional deviation of the frame region 301e as compared with a case where the auxiliary lines 302 and 303 are absent. The reason for this is because a relative position of the frame region 301e based on the auxiliary lines 302 and 303 can be recognized.

The defect determination unit 13 applies the inspection image equipped with auxiliary lines generated by the inspection image generation unit 12 to a trained determination model by using training data to detect a defect related to the positional deviation in any one of the plurality of frame member 101. The trained determination model is stored in advance in the determination model storage unit 14. The determination model is generated by machine learning processing using the training data to output defect information related to the positional deviation when the inspection image equipped with auxiliary lines is input. The defect information output from the determination model may be information indicating presence or absence of a defect (a positional deviation of the frame members 101), or may be information indicating the degree of the positional deviation (for example, an abnormality score).

For example, the determination model is generated for each type of the annular disk 100 shown s in FIG. 2. The defect determination unit 13 detects a defect by using a determination model corresponding to the type of the annular disk 100 to be inspected. Note that one determination model may be used for similar types such as the type shown in FIG. 2(a) and the type shown in FIG. 2(b). One determination model may be used for all types without generating the determination model for each type, but it is preferable to generate a determination model for each type from the viewpoint of improving defect detection performance.

The training data that is used in the machine learning processing of the determination model includes a training image equipped with auxiliary lines similar to the inspection image equipped with auxiliary lines shown in FIG. 3(b). The training image equipped with auxiliary lines is an image in which circular auxiliary lines 302 and 303 are drawn at a predetermined position near the position where the plurality of frame members 101 exist. The training image equipped with auxiliary lines include a defective product image equipped with auxiliary lines in which the auxiliary lines 302 and 303 are drawn with respect to a defective product image generated by causing a positional deviation to occur in any of the frame members 101 through image processing based on a normal product image obtained by imaging a surface of the annular disk 100 that is a normal product without the positional deviation in the plurality of frame members 101.

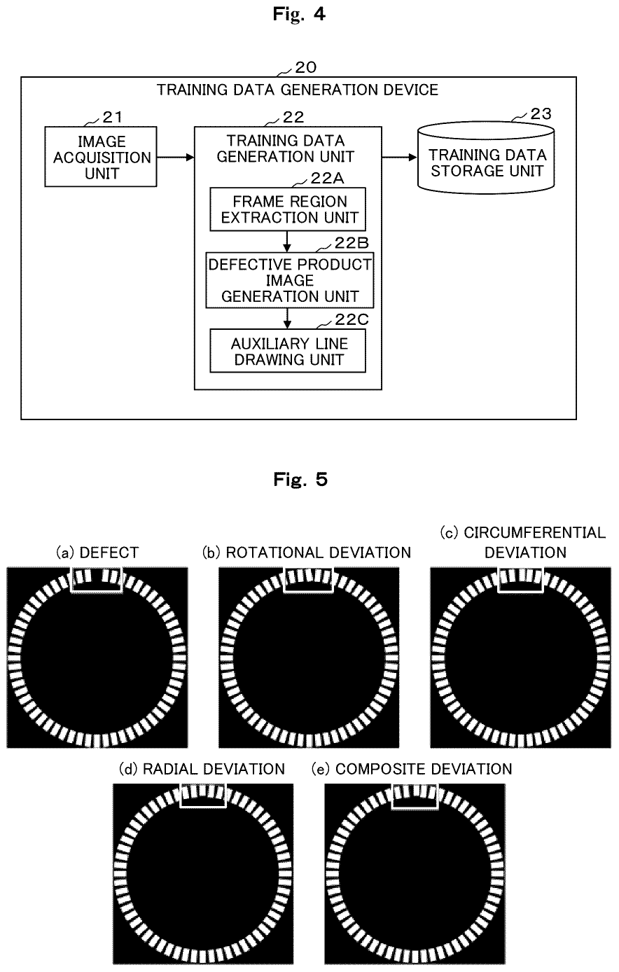

FIG. 4 is a block diagram illustrating a functional configuration example of a training data generation device 20 that generates the training data described above. As shown in FIG. 4, the training data generation device 20 of this embodiment includes an image acquisition unit 21 and a training data generation unit 22 as a functional configuration. The training data generation unit 22 includes a frame region extraction unit 22A, a defective product image generation unit 22B, and an auxiliary line drawing unit 22C as a specific functional configuration. In addition, the training data generation device 20 of this embodiment includes a training data storage unit 23 as a storage medium.

The functional blocks 21 and 22 can be configured by any of hardware, a DSP, and software. For example, in a case of being configured by the software, the functional blocks 21 and 22 include a CPU, a RAM, a ROM, and the like of a computer, and are actually realized when a program stored in a storage medium such as the RAM, the ROM, a hard disk, or a semiconductor memory operates. A GPU, an FPGA, an ASIC, or the like may be used instead of or in addition to the CPU.

The image acquisition unit 21 acquires an image obtained by imaging a surface of an annular disk. The training data generation unit 22 performs image processing on the image acquired by the image acquisition unit 21, and draws a circular auxiliary line at a predetermined position near the position where the plurality of frame members 101 exist to generate training image equipped with auxiliary lines, and stores the training image in the training data storage unit 23 as training data.

Here, the image acquisition unit 21 and the training data generation unit 22 can generate the training data, for example, as follows. That is, the image acquisition unit 21 acquires a plurality of defective product images obtained by imaging surfaces of annular disks which are a plurality of defective products in which the positional deviation exists in any of the frame members 101. Then, the training data generation unit 22 draws an auxiliary line on the plurality of defective product images acquired by the imaging through image processing to generate a plurality of training images equipped with auxiliary lines.

Note that in this method, it is necessary to prepare and image a plurality of annular disks which are defective products. In reality, since the defective products are not manufactured so much, it is difficult to acquire the defective product images in a number capable of sufficiently raising learning accuracy. Therefore, the image acquisition unit 21 and the training data generation unit 22 may generate the training data as follows. That is, the image acquisition unit 21 acquires a normal product image obtained by imaging a surface of the annular disk 100 that is a normal product without the positional deviation in the plurality of frame members 101. The training data generation unit 22 generates a plurality of defective product images by image processing on the normal product image, and draws an auxiliary line on the plurality of generated defective product images to generate a plurality of training images equipped with auxiliary lines.

Here, similar to the frame region extraction unit 12A shown in FIG. 1, the frame region extraction unit 22A generates an extraction image obtained by extracting the plurality of frame members 101 or a region where the plurality of frame members 101 are arranged from the normal product image acquired by the image acquisition unit 21.

The defective product image generation unit 22B performs image processing on the extraction image generated from the normal product image by the frame region extraction unit 22A, and causes a positional deviation to occur in any of the frame members 101 (frame region 301) to generate a defective product image. Here, the defective product image generation unit 22B generates, for example, a plurality of defective product images which are different in the type of the positional deviation.

FIG. 5 is a view illustrating examples of the type of the positional deviation. FIG. 5(a) shows a deficiency of any of the frame members 101. FIG. 5(b) shows a rotational deviation of any of the frame members 101. FIG. 5(c) shows a circumferential deviation of any of the frame members 101. FIG. 5(d) shows a radial deviation of any of the frame members 101. FIG. 5(e) shows a composite deviation related to at least two among the rotational deviation, the circumferential deviation, and the radial deviation of any of the frame members 101. The defective product image generation unit 22B generates a plurality of defective product images including any of the deficiency, the rotational deviation, the circumferential deviation, the radial deviation, and the composite deviation based on the normal product image.

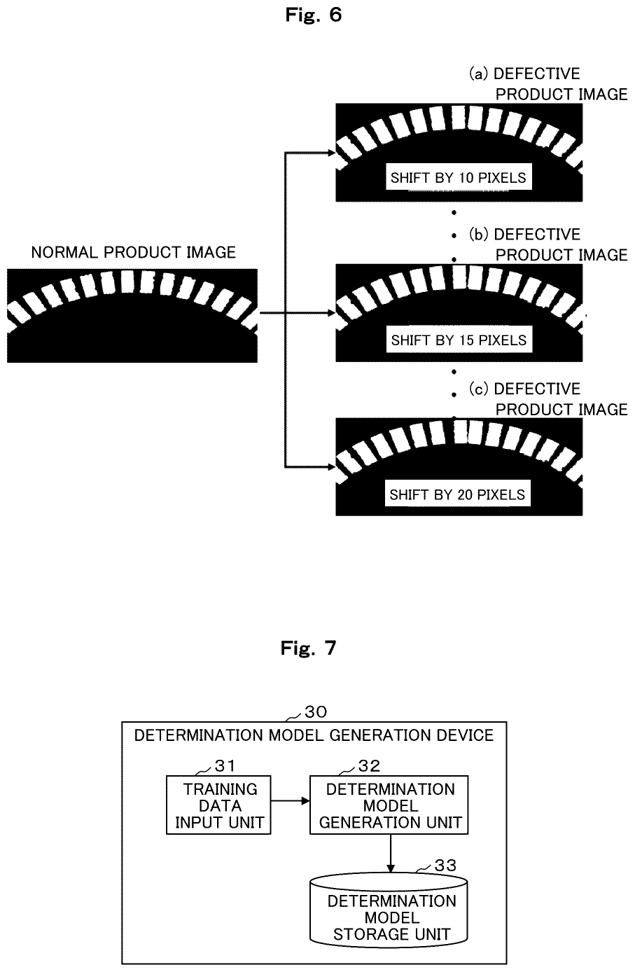

In addition, the defective product image generation unit 22B generates, for example, a plurality of defective product images which are different in the amount of the positional deviation based on the normal n product image. FIG. 6 is a view showing a generation example of the plurality of defective product images which are different in the amount of positional deviation. FIG. 6 shows a generation example of defective product images in which the circumferential deviation is caused to occur, and shows a defective product image in which one frame member 101 is shifted by 10 pixels from a normal position in a circumferential direction (FIG. 6(a), a defective product image in which the frame member 101 is shifted by 15 pixels from the normal position in the circumferential direction (FIG. 6(b) ), and a defective product image in which the frame member 101 is shifted by 20 pixels form the normal position in the circumferential direction is exemplified (FIG. 6(c)). The defective product image generation unit 22B also performs the processing with respect to the rotational deviation, the radial deviation, and the composite deviation.

Similar to the auxiliary line drawing unit 12B shown in FIG. 1, the auxiliary line drawing unit 22C draws the auxiliary lines 302 and 303 at a predetermined position near the position where the plurality of frame members 101 (frame region 301) exist in the defective product image generated by the defective product image generation unit 22B to generate the training image equipped with auxiliary lines.

Through the processing by the frame region extraction unit 22A, the defective product image generation unit 22B, and the auxiliary line drawing unit 22C described above, the training data generation unit 22 generates a plurality of defective product images equipped auxiliary lines which are different in the type of the positional deviation as the training image equipped with auxiliary lines. In addition, the training data generation unit 22 generates a plurality of defective product image equipped with auxiliary lines which are different in the amount of the positional deviation as the training image equipped with auxiliary lines. The training data generation unit 22 stores the generated training images equipped with auxiliary lines in the training data storage unit 23.

Note that here, description has been given of an example in which the defective product images equipped with auxiliary lines are generated as the training image equipped with auxiliary lines, and are set as the training data, but there is no limitation to the example. For example, the processing of the frame region extraction unit 22A and the auxiliary line drawing unit 22C may also be executed with respect to the normal product image acquired by the image acquisition unit 21 to generate a normal product image equipped with auxiliary lines, and the normal product image equipped with auxiliary lines and the defective product images equipped with auxiliary lines may be set as the training image equipped with auxiliary lines (training data). In this case, a normal product label is applied to the normal product image equipped with auxiliary lines, and a defective product label is applied to the defective product image equipped with auxiliary lines.

FIG. 7 is a block diagram illustrating a functional configuration example of a determination model generation device 30 that generates a determination model by using the training data generated by the training data generation device 20 as described. As shown in FIG. 7, determination model generation device 30 of this embodiment includes a training data input unit 31 and a determination model generation unit 32 as a functional configuration. In addition, the determination model generation device 30 of this embodiment includes a determination model storage unit 33 as a storage medium.

The functional blocks 31 and 32 can be configured by any of hardware, a DSP, and software. For example, in a case of being configured by the software, the functional blocks 31 and 32 include a CPU, a RAM, a ROM, and the like of a computer, and are actually realized when a program stored in a storage medium such as the RAM, the ROM, a hard disk, or a semiconductor memory operates. A GPU, an FPGA, an ASIC, or the like may be used instead of or in addition to the CPU.

The determination model generated by the training data input unit 31 inputs the training data generated by the training data generation device 20. The determination model generation unit 32 generates a determination model by executing machine learning processing by using the training data input by the training data input unit 31. The determination model generation unit 32 stores the generated determination model in the determination model storage unit 33. The determination model stored in the determination model storage unit 33 is stored in the determination model storage unit 14 shown in FIG. 1.

The determination model generation unit 32 is a model configured to output defect information related to the positional deviation when the inspection image equipped with auxiliary lines is input, and may also be a determination model that outputs defect information indicating the presence or absence of the positional deviation, or a determination model that output defect information indicating the degree of the positional deviation. The type of the determination model may be any of a regression model, a tree model, a neural network model, a Bayesian model, a clustering model, and the like. Note that the types of the prediction model stated here are merely examples and are not limited to these models.

Note that in the above-described embodiment, description has been given of an example in which the training data generation device 20 and the determination model generation device 30 are configured as separate devices, but the devices may be configured as one device. In addition, the devices may be configured as one device by further adding the defect inspection device 10 shown in FIG. 1 thereto.

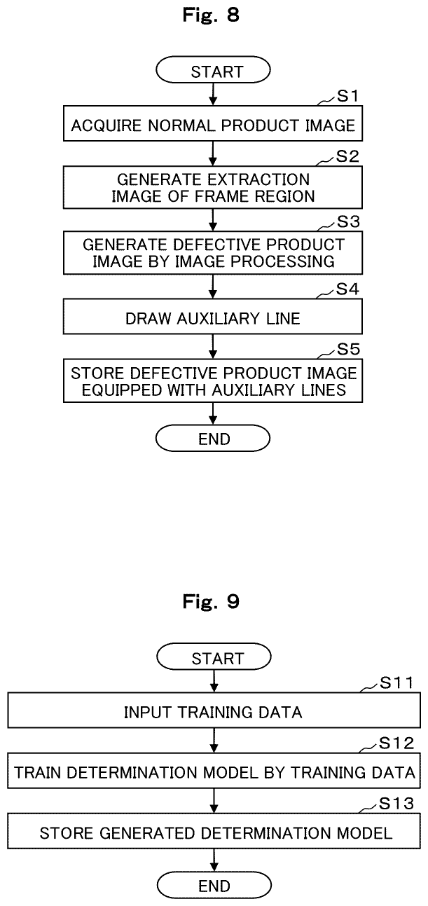

FIG. 8 is a flowchart illustrating an operation example of the training data generation device 20 configured as described above. In FIG. 8, first, the image acquisition unit 21 acquires a normal product image obtained by imaging a surface of an annular disk that is a normal product (step S1). Next, the frame region extraction unit 22A of the training data generation unit 22 generates an extraction image of the frame region 301 obtained by extracting the plurality of frame members 101 or a region where the plurality of frame members 101 are arranged from the normal product image acquired by the image acquisition unit 21 (step S2).

Next, the defective product image generation unit 22B performs image processing on the extraction image generated from the normal product image by the frame region extraction unit 22A, and causes the positional deviation to occur in the any of the frame members 101 (frame region 301) to generate a defective product image (step S3). Here, the defective product image generation unit 22B generates, for example, a plurality of defective product images which are different in the type of the positional deviation, and a plurality of defective product images which are different in the amount of the positional deviation.

Then, the auxiliary line drawing unit 22C draws the auxiliary lines 302 and 303 at a predetermined position near the position where the plurality of frame members 101 exist in each of the plurality of defective product images generated by the defective product image generation unit 22B to generate a defective product image equipped with auxiliary lines (step S4), and stores the defective product image equipped with auxiliary lines in the training data storage unit 23 as the training image equipped with auxiliary lines (training data) (step S5). According to this, the processing in the flowchart shown in FIG. 8 is terminated.

FIG. 9 is a flowchart illustrating an operation example of the determination model generation device 30 configured as described above. In FIG. 9, first, the training data input unit 31 inputs the training data generated by the training data generation device 20 (step S11). Then, the determination model generation unit 32 executes machine learning processing by using the input training data to generates a determination model (step S12), and stores the generated determination model in the determination model storage unit 33 (step S13). According to this, the processing in the flowchart shown in FIG. 9 is terminated.

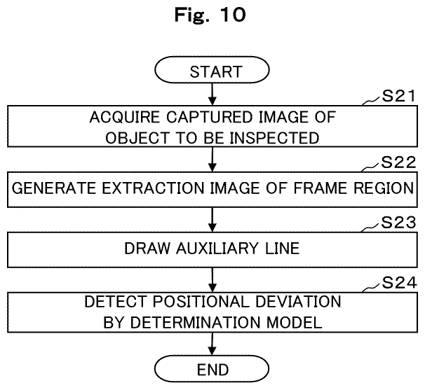

FIG. 10 is a flowchart illustrating an operation example of the defect inspection device 10 configured as described above. In FIG. 10, first, the image acquisition unit 11 acquires an image obtained by imaging a surface of an annular disk that is object to be inspected (step S21). Next, the frame region extraction unit 12A of the inspection image generation unit 12 generates an extraction image of the frame region 301 obtained by extracting the plurality of frame members 101 or a region where the plurality of frame members 101 are arranged from the image acquired by the image acquisition unit 11 (step S22).

Next, the auxiliary line drawing unit 12B draws the auxiliary lines 302 and 303 at a predetermined position near the position where the plurality of frame members 101 exist on the extraction image generated by the frame region extraction unit 12A to generate inspection image equipped with auxiliary lines (step S23). Then, the defect determination unit 13 applies the inspection image equipped with auxiliary lines generated by the inspection image generation unit 12 to a trained determination model stored in the determination model storage unit 14, and detects a defect related to the positional deviation in any one of the plurality of frame members 101 (step S24). That is, the defect determination unit 13 inputs the inspection image equipped with auxiliary lines to the determination model, and outputs defect information indicating presence or absence of the positional deviation or defect information indicating the degree of the positional deviation (for example, an abnormality score) from the determination model. According to this, the processing of the flowchart shown in FIG. 10 is terminated.

As described in detail, in this embodiment, imaging processing is performed on an image obtained by imaging the surface of the annular disk 100, and draws the circular auxiliary lines 302 and 303 at a predetermined position near the position where the plurality of frame members 101 exist to generate the inspection image equipped with auxiliary lines. Then, the generated inspection image equipped with auxiliary lines is applied to the trained determination model by using the training data to detect a defect related to the positional deviation in any one of the plurality of frame members 101. Here, the determination model is generated by machine learning processing using training data including a training image equipped with auxiliary lines which is similar to the inspection image equipped with auxiliary lines, and outputs defect information related to the positional deviation when the inspection image equipped with auxiliary lines is input.

According to this embodiment configured as described above, since the positional deviation of the frame members 101 is determined by using the determination model generated by the machine learning using the training data instead of determining the positional deviation based on various values calculated with respect to the frame members 101 by image processing on a captured image of the annular disk 100, it is not necessary to set a specified value for comparison with the calculation values, and thus even in a case where a noise is included in the captured image of the annular disk 100, it is possible to reduce the possibility of occurrence of erroneous determination by an adverse effect on the comparison between the calculation values and the specified value due to the noise. In addition, since the determination of the positional deviation is performed based on the inspection image equipped with auxiliary lines by using the determination model generated by the machine learning using the training image equipped with auxiliary lines as the training data, it is easy to determine learning and determination of the positional deviation occurring in the frame members 101 by using the auxiliary lines 302 and 303 as a reference. As described above, according to the defect inspection device 10 of this embodiment, it is possible to improve detection performance of the positional deviation of the frame members 101.

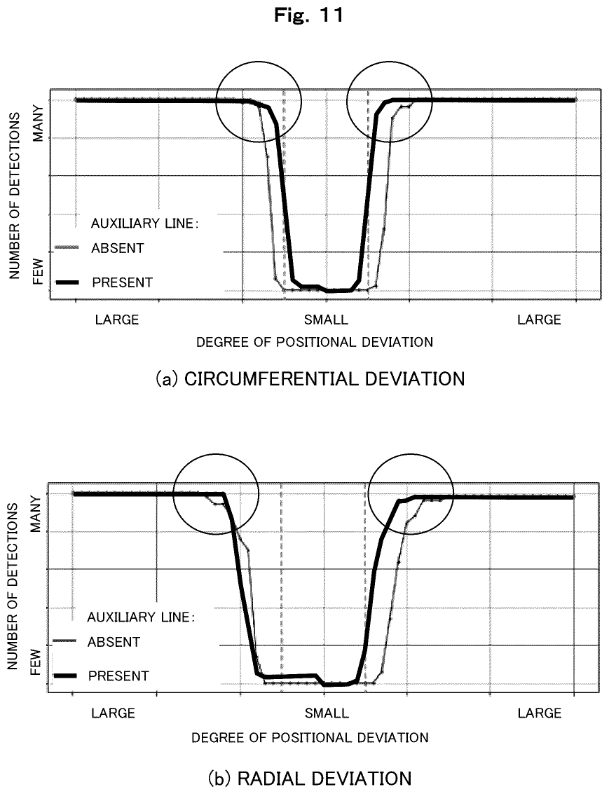

FIG. 11 is a view illustrating a result obtained by performing defect inspection with respect to a plurality of the annular disks 100 by using the determination model configured to detect presence or absence of the positional deviation. FIG. 11 is a view showing a different in positional deviation detection performance between a case where the auxiliary lines 302 and 303 are present and a case where auxiliary lines 302 and 303 are absent with regard to the circumferential deviation and the radial deviation, FIG. 11(a) shows circumferential deviation detection performance, and FIG. 11(b) shows radial deviation detection performance.

In FIG. 11, the horizontal axis represents the degree of the positional deviation, the positional deviation is the smallest at the center, and the positional deviation is larger as being away from the center to the right and the left. The vertical axis represents the number of objects to be inspected in which the positional deviation can be detected. With regard to any of the circumferential deviation and the radial deviation, a valley in the number of detections is narrower in a case where the auxiliary lines 302 and 303 are present as compared with a case where auxiliary lines 302 and 303 are absent. That is, as shown in FIG. 11 by circular marks, the number of detections of a smaller positional deviation is larger in a case where the auxiliary lines 302 and 303 are present.

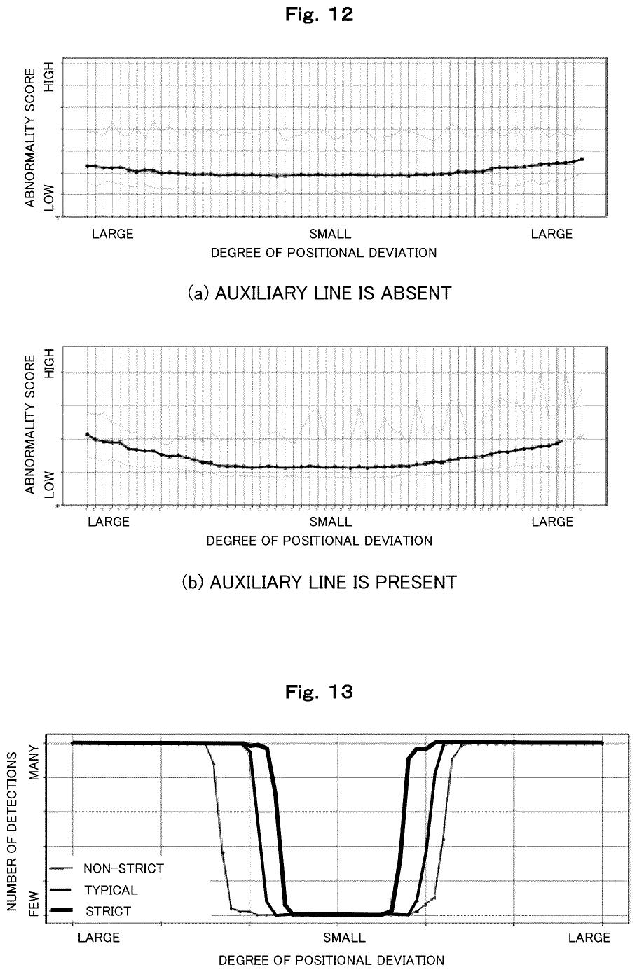

FIG. 12 is a view illustrating a result obtained by performing a defect inspection with respect to the plurality of annular disks 100 by using the determination model configured to output defect information (abnormality score) indicating the degree of the positional deviation. FIG. 12 is a view showing a difference in positional deviation detection performance between a case where the auxiliary lines 302 and 303 are present and a case where the auxiliary lines 302 and 303 are absent with regard to the circumferential deviation, FIG. 12(a) shows detection performance in a case where the auxiliary lines 302 and 303 are absent, and FIG. 12(b) shows detection performance in a case where the auxiliary lines 302 and 303 are present.

In FIG. 12, the horizontal axis represents the degree of the positional deviation, the positional deviation is the smallest at the center, and the positional deviation is larger as being away from the center to the right and the left. The vertical axis represents an abnormality score. As shown in FIG. 12(a), in a case where the auxiliary lines 302 and 303 are absent, the abnormality score does not increase greatly even though the degree of the positional deviation increases. In contrast, as shown in FIG. 12(b), in a case where the auxiliary lines 302 and 303 are present, as the degree of the positional deviation increases, the abnormality score also increases greatly. That is, in a case where the auxiliary lines 302 and 303 are present, a valley of the abnormality score is deeper as compared with the case where auxiliary lines 302 and 303 are absent, and thus it can be seen that the degree of the positional deviation can be detected with more accuracy as compared with the case where the auxiliary lines 302 and 303 are absent.

As shown in FIG. 11 and FIG. 12, with regard to any of the determination model configured to output defect information indicating presence of absence of the positional deviation, and the determination model configured to output defect information indicating the degree the positional deviation, it is possible to improve the positional deviation detection performance of the frame members 101 by drawing the auxiliary lines 302 and 303.

In addition, in this embodiment, since the plurality of defective product images equipped with auxiliary lines are generated by image processing on the normal product image obtained by imaging the annular disk 100 that is a normal product, a plurality of pieces of training data can be easily generated. There is known a method of generating a defective product image by overwriting a specific defect image on a normal product image (for example, refer to JP 2021-135903A), or a method of generating a defective product image by machine learning (for example, refer to JP 2022-108855A), but the former has a disadvantage that a large number of defect images are to be prepared, and the latter has a disadvantage that it takes effect to build a system for the machine learning. In contrast, according to this embodiment, it is possible to easily generate various training images equipped with auxiliary lines by simple processing called image processing on the normal product image.

In addition, in this embodiment, since the plurality of defective product images equipped with auxiliary lines are generated by the image processing on the normal product image, it is easy to generate the determination model by setting a plurality of defective product images equipped with auxiliary lines in which the type of the positional deviation is the same as a group of training data set, to generate the determination model by setting a plurality of defective product image equipped with auxiliary lines in which the magnitude of the positional deviation is in the same level as a group of training data set, or to generate the determination model by setting a plurality of defective product images equipped with auxiliary lines in which the type of the positional deviation is the same and the magnitude of the positional deviation is in the same level as a group of training data set.

For example, the training data generation unit 22 of the training data generation device 20 may generate training images equipped with auxiliary lines, which do not include defective product images equipped auxiliary lines which are different in the type of the positional deviation and defective product images equipped with auxiliary lines in which the amount of the positional deviation is within a predetermined amount, and which include a plurality of defective product images equipped with auxiliary lines in which the type of the positional deviation is the same and the amount of the positional deviation is different by an extent more than the predetermined amount, as a group of training data set. In this case, the determination model generation unit 32 of the determination model generation device 30 generates the determination model by machine learning processing using the group of training data set. For example, in a specific type of positional deviation, in a case of an application in which it is desired to detect a positional deviation of which the amount of deviation is larger than a predetermined amount, it is possible to generate a determination model according to the application by generating a group of training data set described above and performing the machine learning processing.

In addition, the training data generation unit 22 may generate a plurality of training data sets for each type of the positional deviation. In addition, the training data generation unit 22 may generate a plurality of groups of training data sets for each type of the positional deviation and for each magnitude of the amount of deviation (the above-described predetermined amount). In these cases, the determination model generation unit 32 of the determination model generation device 30 generate a plurality of determination model individually using the plurality of groups of generated training data sets in the machine learning processing.

In this case, in correspondence with an application in which what type of positional deviation is desired to be detected, or which magnitude of positional deviation is desired to be detected, it is possible to perform a defect inspection by using a determination model according to the application. In this case, the defect determination unit 13 of the defect inspection device 10 applies the inspection image equipped with auxiliary lines generated by the inspection image generation unit 12 to any one or a plurality of determination models among the plurality of determination models and detects a defect related to the positional deviation in any one of the plurality of frame members 101.

FIG. 13 is a view showing results obtained by generating three groups of training data sets (data sets of training images equipped with auxiliary lines) divided based on the magnitude of the amount of deviation of the circumferential deviation, and by performing a circumferential deviation detection based on three determination models generated by the machine learning processing individually using the three groups of training data sets. In FIG. 13, the horizontal axis represents the degree of positional deviation, and the positional deviation is the smallest at the center, and the positional deviation is larger as being away from the center to the right and the left. The vertical axis represents the number of objects to be detected in which the positional deviation can be detected. As shown in FIG. 13, it is possible to generate three determination models having different detection performance by using the training data sets generated in three divided groups based on the magnitude of the amount of deviation.

Note that in the above-described embodiment, description has been given of an example of generating a determination model that output defect information indicating presence or absence of the positional deviation, or a determination model that outputs defect information indicating the degree of positional deviation, but the invention is not limited thereto. For example, the defect information that is output by the determination model may include information indicating a position of the frame member 101 in which the positional deviation occurs, or may include information indicating the type of the positional deviation.

For example, in a case of generating the determination model that outputs the information indicating the position of the positional deviation in combination with the information indicating the presence or absence or the degree of the positional deviation as defect information, the training data generation unit 22 of the training data generation device 20 generates the training image equipped with auxiliary lines, and adds the position information indicating the position of the frame member 101 in which the positional deviation is caused to occur to generate the training data.

In this embodiment, since the defective product image is generated by image processing on any frame region 301 included in the normal product image, a position of the frame region 301 in which the positional deviation is caused to occur is recognized by the defective product image generation unit 22B in image processing. Accordingly, it is possible to automatically add the position information to the training image equipped with auxiliary lines in image processing. According to this, it is not necessary to manually apply the position information to each training image equipped with auxiliary lines, and it is possible to efficiently generate the training data equipped with the position information.

In addition, in a case of generating the determination model that outputs information indicating the type of the positional deviation in combination with information indicating the presence or absence or the degree of the positional deviation as the defect information, the training data generation unit 22 of the training data generation device 20 generates a training image equipped with auxiliary lines and adds type information indicating the type of the positional deviation to generate the training data. Since the type of the positional deviation can be recognized by the defective product image generation unit 22B in image processing, it is possible to automatically add the type information to the training image equipped with auxiliary lines in image processing.

In addition, in the above-described embodiment, description has been given of an example in which the plurality of frame members 101 are arranged side by side with predetermined intervals along the surface of the annular disk 100 in the circumferential direction, and the circular auxiliary lines 302 and 303 are drawn, but the invention is not limited thereto. Specifically, a member on which the plurality of frame members 101 are arranged is not necessarily to be an annular member, and the auxiliary lines 302 and 303 are not necessary to be circular. For example, a plurality of frame members may be arranged side by side on a rectangular member with predetermined intervals in a rectangular circumferential direction, and in this case, the auxiliary lines may have a rectangular shape or may be a plurality of straight lines.

In addition, in the above-described embodiment, description has been given of an example in which image processing such as binarization and gradation inversion is performed on a captured image of the annular disk 100 to generate an extraction image obtained by extracting the plurality of frame members 101 or the region where the plurality of frame members 101 are arranged, but the processing may be omitted. That is, the auxiliary lines 302 and 303 may be drawn on the captured image of the annular disk 100 in which the plurality of frame members 101 are included as is. However, by narrowing an analysis range by deleting useless elements other than the plurality of frame members 101, an influence on the machine learning processing or the determination processing due to the useless elements is avoided, and thus it is possible to improve defect detection performance.

In addition, the above-described embodiment is merely an example of specific embodiment t for carrying out the invention, and the technical scope of the invention should not be interpreted as being limited by the embodiment. That is, the invention can be carried out in various forms without departing from the gist or main characteristics of the invention.

### REFERENCE SIGNS LIST

10: defect inspection device
11: image acquisition unit
12: inspection image generation unit
12A: frame region extraction unit
12B: auxiliary line drawing unit
13: defect determination unit
14: determination model storage unit
20: training data generation device
21: image acquisition unit
22: training data generation unit
22A: frame region extraction unit
22B: defective product image generation unit
22C: auxiliary line drawing unit
23: training data storage unit
30: determination model generation device
31: training data input unit
32: determination model generation unit
33: determination model storage unit
100: annular disk
101: frame member (fraction material)
301: frame region
302: inner circumferential circle (auxiliary line)
303: outer circumferential circle (auxiliary line)

1. A defect inspection device configured to detect a defect related to a positional deviation of a plurality of frame members arranged side by side with predetermined intervals, the defect inspection device comprising:
an image acquisition unit configured to acquire an image obtained by imaging the plurality of frame members;
an inspection image generation unit configured to perform image processing on the image acquired by the image acquisition unit and draw auxiliary lines at a predetermined position near a position where the plurality of frame members exist to generate an inspection image equipped with auxiliary lines; and
a defect determination unit configured to apply the inspection image equipped with auxiliary lines generated by the inspection image generation unit to a determination model trained by using training data and detect the defect related to the positional deviation in any one of the plurality of frame members,
wherein the training data is a training image equipped with auxiliary lines in which the auxiliary lines are drawn at the predetermined position near the position where the plurality of frame members exist, and
the determination model is generated by machine learning processing using the training data to output defect information related to the positional deviation when the inspection image equipped with auxiliary lines is input.

2. The defect inspection device according to claim 1,
wherein the plurality of frame members are arranged side by side with predetermined intervals in a circumferential direction along a surface of an annular disk, and
the inspection image generation unit draws at least one of an inner circumferential circle on an inner side of the plurality of frame members and an outer circumferential circle on an outer side of the plurality of frame members as the auxiliary lines in the vicinity of the position where the plurality of frame members exist.

3. The defect inspection device according to claim 1,
wherein the inspection image generation unit generates an extraction image obtained by extracting the plurality of frame members or a region where the plurality of frame members are arranged from the image acquired by the image acquisition unit, and draws the auxiliary lines at a predetermined position near the position where the plurality of frame members exist in the extraction image to generate the inspection image equipped with auxiliary lines.

4. The defect inspection device according to claim 1,
wherein the training image equipped with auxiliary lines includes a defective product image equipped with auxiliary lines in which the auxiliary lines are drawn with respect to the defective product image generated by causing a positional deviation to occur in any of the frame members through image processing based on a normal product image obtained by imaging a normal product in which the positional deviation is not present in the plurality of frame members.

5. The defect inspection device according to claim 4, wherein the training image equipped with auxiliary lines includes a plurality of the defective product images equipped with auxiliary lines which are different in a type of the positional deviation.

6. The defect inspection device according to claim 4,
wherein the defective product image equipped with auxiliary lines includes any of a deficiency of any of the frame members, a rotational deviation of any of the frame members, a circumferential deviation of any of the frame members, a radial deviation of any of the frame members, and a composite deviation related to at least two of the rotational deviation, the circumferential deviation, and the radial deviation of any of the frame members.

7. The defect inspection device according to claim 4,
wherein the training image equipped with auxiliary lines includes a plurality of the defective product images equipped with auxiliary lines which are different the amount of the positional deviation.

8. The defect inspection device according to claim 4,
wherein the training image equipped with auxiliary lines, which does not include the defective product image equipped with auxiliary lines in which a type of the positional deviation is different and the defective product image equipped with auxiliary lines in which the amount of the positional deviation is within a predetermined amount, and which includes a plurality of the defective product images equipped with auxiliary lines which are generated such that the type of the positional deviation is the same and the amount of the positional deviation is different by an extent more than the predetermined amount, is set as a group of training data set, and
the determination model is generated by machine learning processing using the group of training data set.

9. The defect inspection device according to claim 8,
wherein a plurality of groups of training data sets are formed for each type of the positional deviation, and
the determination model includes a plurality of determination models generated by machine learning processing individually using the plurality of groups of training data sets.

10. The defect inspection device according to claim 8,
wherein a plurality of groups of training data sets are formed for each type of the positional deviation and each magnitude of the predetermined amount, and
the determination model includes a plurality of determination models generated by machine learning processing individually using the plurality of groups of training data sets.

11. The defect inspection device according to claim 9,
wherein the defect determination unit applies the inspection image equipped with auxiliary lines with respect to any one or a plurality of determination models among the plurality of determination models and detects a defect related to a positional deviation in any of the plurality of frame members.

12. The defect inspection device according to claim 4,
wherein the training data is data added position information indicating a position of a frame member that causes the positional deviation to occur to the defective product image equipped with auxiliary lines, and
the defect information that is output by the determination model includes information indicating the position of the positional deviation.

13. A defect inspection method of detecting a defect related to a positional deviation of a plurality of frame members arranged side by side with predetermined intervals, the defect inspection method comprising:
a first step of acquiring an image obtained by imaging the plurality of frame members by an image acquisition unit of a defect inspection device;
a second step of performing image processing on the image acquired by the image acquisition unit, and drawing auxiliary lines at a predetermined position near a position where the plurality of frame members exist by an inspection image generation unit of the defect inspection device to generate an inspection image equipped with auxiliary lines; and
a third step of applying the inspection image equipped with auxiliary lines generated by the inspection image generation unit to a determination model trained by using training data by a defect determination unit of the defect inspection device to detect the defect related to the positional deviation in any one of the plurality of frame members,
wherein the training data is a training image equipped with auxiliary lines in which the auxiliary lines are drawn at a predetermined position near the position where the plurality of frame members exist, and
the determination model is generated by machine learning processing using the training data to output defect information related to the positional deviation when the inspection image equipped with auxiliary lines is input.

14. A training data generation method, the training data being used in machine learning of a determination model used for determination of a positional deviation of a plurality of frame members arranged side by side with predetermined intervals, the training data generation method comprising:
a first step of acquiring an image obtained by imaging the plurality of frame members by an image acquisition unit of a computer; and
a second step of performing image processing on the image acquired by the image acquisition unit, and drawing auxiliary lines at a predetermined position near a position where the plurality of frame members exist by a training data generation unit of the computer to generate a training image equipped with auxiliary lines,
wherein the training image equipped with auxiliary lines generated by the training data generation unit is set as the training data.

15. The training data generation method according to claim 14,
wherein the image acquisition unit acquires a normal product image obtained by imaging a normal product in which the positional deviation is not present in the plurality of frame members, and
the training data generation unit generates a defective product image by causing the positional deviation to occur in any of the frame members through image processing on the normal product image, and draws the auxiliary lines at a predetermined position near a position where the plurality of frame members exist on the defective product image to generate the training image equipped with auxiliary lines.

16. The training data generation method according to claim 15,
wherein the training data generation unit generates a plurality of the defective product images equipped with auxiliary lines which are different in a type of the positional deviation as the training image equipped with auxiliary lines.

17. The training data generation method according to claim 15,
wherein the training data generation unit generates the defective product image equipped with auxiliary lines which includes any of a deficiency of any of the frame members, a rotational deviation of any of the frame members, a circumferential deviation of any of the frame members, a radial deviation of any of the frame members, and a composite deviation related to at least two of the rotational deviation, the circumferential deviation, and the radial deviation of any of the frame members as the training image equipped with auxiliary lines.

18. The training data generation method according to claim 15,
wherein the training data generation unit generates a plurality of the defective product images equipped with auxiliary lines, which are different in the amount of the positional deviation, as the training image equipped with auxiliary lines.

19. The training data generation method according to claim 15,
wherein the training data generation unit generates the training image equipped with auxiliary lines, which does not include the defective product image equipped with auxiliary lines in which a type of the positional deviation is different and the defective product image equipped with auxiliary lines in which the amount of the positional deviation is within a predetermined amount, and which includes a plurality of the defective product images equipped with auxiliary lines in which the type of the positional deviation is the same and the amount of the positional deviation is different by an extent more than the predetermined amount, as a group of training data set.

20. The training data generation method according to claim 19,
wherein the training data generation unit generates a plurality of groups of training data sets for each type of the positional deviation.

21. The training data generation method according to claim 19,
wherein the training data generation unit generates a plurality of groups of training data sets for each type of the positional deviation and each magnitude of the predetermined amount.

22. The training data generation method according to claim 15,
wherein the training data generation unit generates the training image equipped with auxiliary lines, and adds position information indicating a position of a frame member that causes the positional deviation to generate the training data.

23. A determination model generation method of generating a determination model that is used in determination of a positional deviation of a plurality of frame members arranged side by side with predetermined intervals by machine learning using training data,
wherein a determination model generation unit of a computer generates the determination model by machine learning processing using the training data generated by the training data generation method according to claim 14.

24. A determination model generation method of generating a determination model that is used in determination of a positional deviation of a plurality of frame members arranged side by side with predetermined intervals by machine learning using training data,
wherein a determination model generation unit of a computer generates a plurality of the determination models by machine learning processing individually using a plurality of groups of training data sets generated by the training data generation method according to claim 20.
